(19) United States
(12) Patent Application Publication
(10) Pub. No.: US 2019/0370693 A1
(43) Pub. Date: Dec. 5, 2019

(54) POWER FACTOR CORRECTION BASED ON MACHINE LEARNING FOR ELECTRICAL DISTRIBUTION SYSTEMS

(71) Applicant: Oracle International Corporation, Redwood Shores, CA (US)

(72) Inventors: Benjamin P. Franklin, JR., Jasper, GA (US); Andrew I. Vakhutinsky, Sharon, MA (US); Kenny C. Gross, Escondido, CA (US)

(73) Assignee: Oracle International Corporation, Redwood Shores, CA (US)

(21) Appl. No.: 15/993,439

(22) Filed: May 30, 2018

(51) Int. Cl. G06N 99/00; G05B 15/02; H02J 3/18; H02J 13/00; G01W 1/10

(52) U.S. Cl. CPC G06N 99/005; G05B 15/02; H02J 3/383; H02J 13/0017; G01W 1/10; H02J 3/18

(57) ABSTRACT

The disclosed embodiments relate to a system that performs power factor correction in an electrical distribution system. During operation, the system receives electrical usage data specifying both reactive and resistive loads from a set of smart meters, wherein each smart meter in the set gathers electrical usage data from a customer location in the electrical distribution system. The system also receives weather forecast data for a region served by the electrical distribution system. The system then feeds the electrical usage data and the weather forecast data into a machine-learning model, which was previously trained on historic electrical usage data and historic weather data, to generate predictions for reactive and resistive loads in the electrical distribution system. Finally, the system adjusts capacitive elements in distribution feeds of the electrical distribution system based on the predicted reactive and resistive loads to maintain near-unity power factors for customers of the electrical distribution system.

### BACKGROUND

### Field

The disclosed embodiments generally relate to the design and operation of electrical power distribution systems. More specifically, the disclosed embodiments relate to a technique for performing power factor correction based on machine learning (ML) in an electrical power distribution system.

### Related Art

In electrical distribution systems, power distribution is most efficient when the consumption is a purely resistive load, which for example is associated with incandescent lights, electric stoves and electric space heaters. When this is the case, the voltage and current waveforms are exactly in phase and all energy that is produced is consumed. However, for appliances with inductive motors, such as air conditioners, refrigerators, and florescent lights, the resulting loads consume “reactive power,” for which the current and voltage waveforms are out of phase. When such reactive loads are present, energy storage in the loads results in a phase difference between the current and voltage waveforms. Hence, during each cycle of alternating-current (AC) voltage, extra energy, in addition to energy consumed in the load, is temporarily stored in electric fields in the load, and is then returned to the power grid a fraction of a cycle later. When this is the case, the “power factor,” which is defined as the ratio of the real power flowing into a circuit and the apparent power in the circuit, is less than one. This means that not all of the energy being generated is consumed by the customer.

Although the associated wasted energy does not cost the customer more (because the customer only pays for power that the customer consumes), the large losses to the utility system resulting from such reactive loads cause higher rates for all customers. So residential customers are indirectly paying for the distribution losses caused by these reactive loads.

Note that utilities use a network of capacitors located in distribution feeds to provide “power factor correction” for industrial customers who operate machinery with large reactive loads. However, existing power factor correction techniques rely on manual adjustments of capacitors, which means that the existing techniques do not operate effectively when such reactive loads change dynamically over time.

Hence, what is needed is a new technique for performing power factor correction for both residential and industrial customers in an electrical power distribution system, which does not suffer from the shortcomings of existing techniques.

### SUMMARY

The disclosed embodiments relate to a system that performs power factor correction in an electrical distribution system. During operation, the system receives electrical usage data specifying both reactive and resistive loads from a set of smart meters, wherein each smart meter in the set gathers electrical usage data from a customer location in the electrical distribution system. The system also receives weather forecast data for a region served by the electrical distribution system. The system then feeds the electrical usage data and the weather forecast data into a machine-learning model, which was previously trained on historic electrical usage data and historic weather data, to generate predictions for reactive and resistive loads in the electrical distribution system. Finally, the system adjusts capacitive elements in distribution feeds of the electrical distribution system based on the predicted reactive and resistive loads to maintain near-unity power factors for customers of the electrical distribution system.

In some embodiments, in addition to adjusting the capacitive elements in response to the predicted reactive and resistive loads, the system adjusts solar power inverters for customers with solar power systems.

In some embodiments, the capacitive elements and/or solar power inverters are adjusted using a nonlinear feedback-control mechanism.

In some embodiments, prior to receiving the electrical usage data, the system trains the machine-learning model based on training data comprising the historic electrical usage data and the historic weather data.

In some embodiments, prior to training the machine-learning model, the system performs a house-classification clustering operation on the training data based on housing data obtained from one or more online real estate databases.

In some embodiments, the house-classification clustering operation is performed using a tri-point clustering technique.

In some embodiments, the predicted reactive and resistive loads comprise one or more predicted (Voltage Amperes Reactive) VAR-hour load shape curves projected several hours into the future.

In some embodiments, the machine-learning model comprises a regression model having a two-dimensional dependent variable representing reactive and resistive power components.

In some embodiments, the machine-learning model comprises a deep-learning neural network model in which neural network parameters are fitted using a gradient-descent technique.

In some embodiments, the weather forecast data is converted into a specific weather forecast for each customer location by triangulating data obtained from local weather stations and using a barycentric coordinate technique.

### BRIEF DESCRIPTION OF THE FIGURES

FIG. 1 illustrates a power triangle representing complex power.

FIG. 2 illustrates an electrical utility system comprising a set of generating stations connected to homes and businesses through an electrical grid in accordance with the disclosed embodiments.

FIG. 3 illustrates a machine-learning based system for performing power factor correction in accordance with the disclosed embodiments.

FIG. 4 presents a flow chart illustrating operations involved in performing power factor correction in accordance with the disclosed embodiments.

FIG. 5 presents a flow chart illustrating operations performed prior to performing the power factor correction in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide a system that gathers electrical usage information from smart meters and current weather information from freely available weather feeds. This information is fed into a bivariate real/complex machine-learning model, which is used to predict VAR-hour load shapes that are used to control capacitors in electrical distribution feeds, thereby avoiding losses caused by mismatched phases in the electrical distribution grid.

Note that a sinusoidally alternating voltage applied to a purely resistive load results in an alternating current that is fully in phase with the voltage. However, in many applications it is common for there to exist a “reactive component” in the load, which is caused by capacitance and/or inductance. This reactive component causes the current to change phase with respect to the voltage.

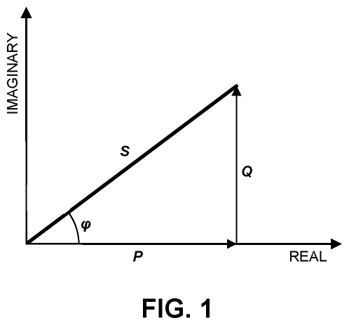

For sinusoid currents and voltages at the same frequency, reactive power expressed in units of VAR (voltage-ampere reactive) is the product of the root-mean square (RMS) voltage and current (apparent power) multiplied by the sine of ϕ, which is the phase angle between the voltage and the current as is illustrated in FIG. 1. The reactive power measured in units of VAR is given by Q =VᵣₘₛIᵣₘₛ sin(ϕ), where Q refers to the maximum value of the instantaneous power absorbed by the reactive component of the load. Note that only effective power, which is the actual power delivered to or consumed by the load, is expressed in watts. The imaginary power component is expressed in VARs. (See https://en.wikipedia.org/wiki/Volt-ampere_reactive.)

“Power factor” is defined as the ratio of true power to apparent power. Note that with purely resistive loads, true power equals apparent power, so the power factor is unity. However, with “reactive loads,” current and voltage are out of phase, and true power is less than apparent power. Hence, with reactive loads, the power factor is less than one, and there are losses in the electrical distribution grid.

For residential customers, the reactive power component varies throughout a 24-hour period; hence, there is a variation in VAR throughout the day. To deal with this variation, we use a machine-learning technique to project VAR load shapes forward in time, and use these VAR load shape forecasts to adjust capacitors in the distribution feed to match phases between the reactive loads and the supplied power. Doing so keeps the power factor near unity, thereby saving significant energy in the power distribution grid. Also, for customers with solar power systems, the same load shape forecasts can be used to control the customers' smart inverters to ensure that the total monthly average power factor approaches unity for those customers as well.

For very large industrial customers that always have a power factor that is significantly less than one, the utility charges a different rate that recognizes the distribution inefficiencies for reactive loads. Also, for such very large industrial customers, utilities often install banks of capacitors into the distribution feeds for the customers, so that the capacitors can be periodically adjusted to raise the power factor.

On the other hand, for residential customers, utilities have not installed capacitors into distribution feeds, but have instead designed the grid as if the power factor is unity for residential customers simply because residential loads were historically almost totally resistive. However, now that air conditioning and CFL lighting are significant components of the electric load for residential customers, and now that a growing portion of residential customers generate solar power that feeds back into the grid, the power factors for residential customers can be significantly less than one.

In a power distribution system, a load with a low power factor draws more current than a load with a unity power factor for the same amount of useful power transferred. These higher currents increase the energy lost in the distribution system, and also require larger wires and larger equipment. Because of these additional requirements, utilities often suffer economic losses when there is a low power factor, and these losses are ultimately passed on to the consumers in higher rates.

Note that if a utility installs capacitors in distribution lines to residential neighborhoods and then optimizes the capacitors (as is already done with industrial customers), the utility does not have to generate VARs all the way back to the power plant and incur all of the line losses. Hence, it is preferable to maintain a unity power factor from the customer loads back to the power plant.

Utility systems often perform Volt/VAR optimization in which they use voltage as the control variable, and optimize voltage as proxy for optimizing VARs. In contrast, the disclosed embodiments use measured VAR load shapes to optimize VARs; not voltage. Note that it is desirable to first optimize VARs to achieve a unity power factor to minimize current and voltage drop loss, and then to optimize voltage, once the VARs are fully optimized. Note that the conventional approach used by utilities has been to optimize voltage first, and then use voltage to optimize VARs, which is very inefficient.

VAR-hour load shape projections have never before been used to optimize VARs. Note that every smart meter includes sensors to measure VAR-hour load shapes, as well as sensors to measure watt-hour load shapes. (The watt-hour load shapes are consumed by the utility to generate customers' bills.) In contrast, the disclosed embodiments use VAR-hour load shapes, computed from real-time sensors in smart meters, which are projected into the future using a machine-learning technique. These projected load shapes are subsequently employed in a feedback-control loop to automatically adjust capacitors in the distribution feeds (as well as inverters in customers' solar power systems) to maintain near-unity power factors for residential customers, thereby avoiding significant losses (up to 20% in regions with high air-conditioning loads) in the electrical distribution system.

The reason that utilities have not previously used VAR-hour load shape forecasts to optimize power factor correction mechanisms is that prior to smart meters the measurements were not previously available. It is also not feasible to simply use real-time VAR-hour measurements to optimize power factor correction mechanisms because it is first necessary to accurately project VAR-hour load shapes into the future, which requires a sophisticated predictive model.

There exist systems that perform load shape predictions for “real power.” However, in contrast to real power, “apparent power” is expressed as a complex number comprising an imaginary component associated with reactive power, and a real component associated with resistive power. Hence, our system implements a machine-learning technique, which is capable of building regression models with two-dimensional dependent variables to represent apparent power with strongly correlated components.

In doing so, our system uses two sets of independent variables (and also a subsequent house-classification clustering operation), which has never been done before for utility VAR-hour load shape projection. These two sets of independent variables are related with time and weather. The time-related variables are associated with different time intervals including: (1) year—the system gathers more than one year of observations to capture a potential annual trend; (2) week—the system considers the week of the year to capture seasonal changes, including the angle of the sun above the horizon; (3) day—the system keeps track of the day of the week to distinguish among weekdays, weekends and holidays; and (4) time of day—the system keeps track of the time of day rounded to the nearest quarter hour, which is the fastest sampling rate for present advanced metering infrastructure (AMI) smart meter readings. The related variables can be associated with: (1) current ambient temperature; (2) ambient temperature for the past two hours; (3) current wind speed; and (4) cloud cover. Note that the weather data for each customer location can be obtained from nearby weather stations using triangulation and a barycentric coordinate technique as described in related U.S. patent application Ser. No. 15/938,988, entitled “Optimally Deploying Utility Repair Assets to Minimize Power Outages During Major Weather Events,” by inventors Kenny C. Gross, et al., filed on 28 Mar. 2018, which is hereby incorporated herein by reference.

The regression model is generated using data from smart meter readings comprising 365×24×4(˜36,000) observations per year representing 15-minute interval measurements of complex-value power consumption. Note that each observation includes both reactive and resistive power.

The system can also use freely available real estate databases to perform a form of clustering called “tri-point clustering,” to facilitate performing bivariate complex regression on groups of similar houses within the same climate zone. (See U.S. Pat. No. 9,514,213, entitled “Per-Attribute Data Clustering Using Tri-Point Data Arbitration,” by inventors Alan Paul Wood, et al., filed on 15 Mar. 2013, which is hereby incorporated herein by reference.) For this clustering operation, an additional set of independent variables is used to account for the differences among the houses. These variables can include: (1) the age of the house; (2) the square footage; (3) the number of floors; (4) the type of roof; and (5) the type of heating. The above type of data can be obtained from online real estate databases, such as Zillow™.

Because energy consumption is essentially non-linear, the disclosed embodiments use a deep-learning network technique, which is well-suited to capture non-linear dependencies and provide multi-dimensional outputs. More specifically, the disclosed embodiments use the following deep-learning neural network architecture:
Input Vector→Sigmoid→Relu→Tanh→Relu→Cost
   where the “→” symbol represents a fully connected layer performing a linear transformation between the previous output vector and the next activation layer. Note that the last linear transformation has two outputs for predicted reactive and resistive power, both of which are optimized for current localized weather conditions and for a specific type of house. The cost function is computed as mean squared error (MSE) of the bivariate predictions over all observations. Also, the fitting of the neural network parameters can be performed via gradient descent to minimize the MSE.

The clustering is performed using a one-year trailing-history load shape for each house to capture characteristics of the energy usage, such as total energy consumption as well as daily consumption patterns. Because each house load shape comprises about 36,000 variables, this approach takes advantage of daily, weekly, and annual cycles, to reduce the input dimension to at most 20 by using a principal component analysis (PCA) technique, which allows us to retain about 99% of the input information. After this dimensionality-reduction operation completes, we use the tri-point clustering technique to form clusters of similar houses.

After the load shape prediction model is generated, the model is subsequently used to predict power consumption for the next several hours using weather forecast information together with time-specific and house-specific values as input parameters for the bivariate real/complex inference model.

Finally, using the prediction for both reactive and resistive power, the system employs an automated feedback-control actuator to adjust the capacitors in the distribution feed. Note that utilities that presently adjust capacitors for their large commercial customers do so manually, not through an automated feedback-control system.

### Utility System

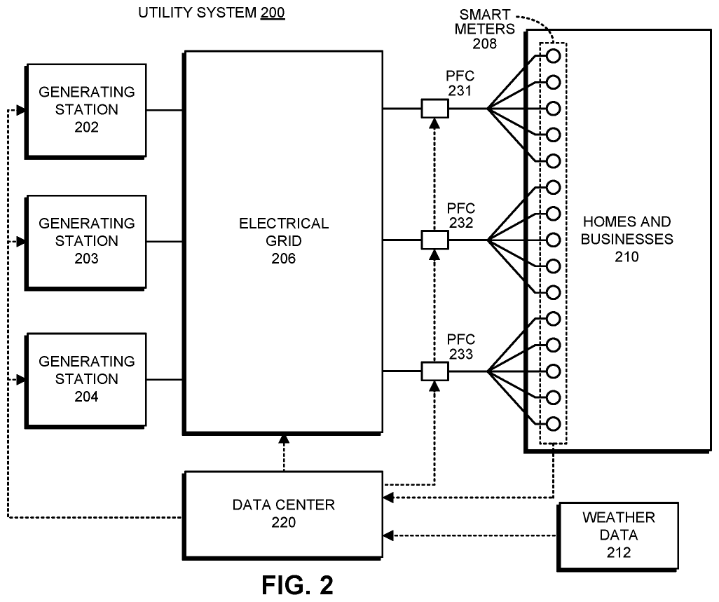

FIG. 2 illustrates an exemplary utility system 200 comprising a set of generating stations 202-204 connected to homes and businesses 210 through an electrical grid 206 in accordance with the disclosed embodiments. Note that generating stations 202-204 can generally include any type of facility that generates electricity, such as a nuclear power plant, a solar power plant, a windmill or a wind “farm,” or a coal-fired, natural gas or oil-burning power plant. Generating stations 202-204 connect into electrical grid 206, which can transfer electricity to homes and businesses 210 within a region served by utility system 200. Note that electrical grid 206 transfers electricity to homes and businesses 210 through individual smart meters 208, which periodically transmit AMI signals containing electrical usage data, including kilowatt measurements and kilowatt-hour measurements, to a data center 220.

A control system within data center 220 receives the AMI signals from smart meters 208 along with weather data 212, comprising historic, current and forecasted weather information, and produces a load forecast, which is used to control generating stations 202-204 and other operations of electrical grid 206. This includes controlling power factor correction (PFC) circuitry 231-233 comprising capacitive elements located in distribution feeds. The operations involved in computing this load forecast and controlling the PFC circuitry 231-233 are discussed in further detail below.

### Power Factor Correction System

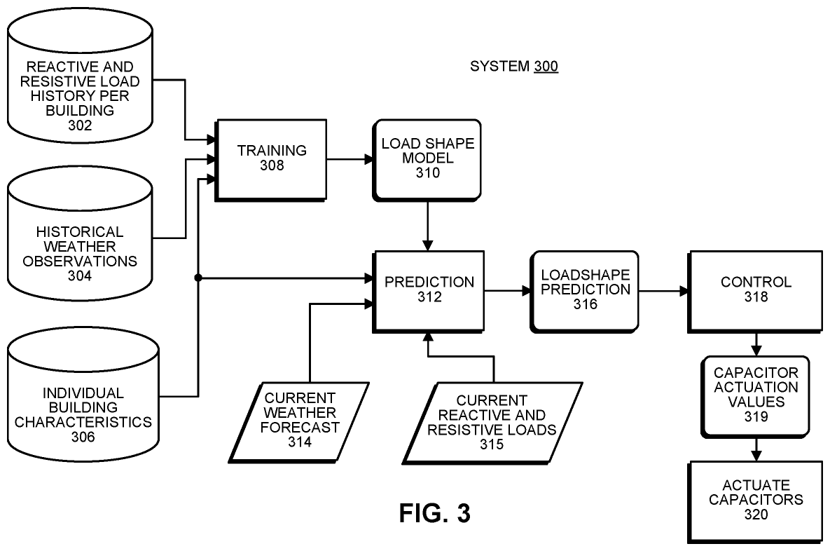

FIG. 3 illustrates a machine-learning based system 300 for performing power factor correction in accordance with the disclosed embodiments. System 300 includes a training module 308, which receives training data including: a reactive and resistive load history per building 302 obtained from smart meter readings; historical weather observations 304 obtained from weather feeds; and individual building characteristics 306 obtained for online real estate databases. Training module 308 uses this training data to produce a load shape model 310.

Next, a prediction module 312 uses load shape model 310 along with a current weather forecast 314, current reactive and resistive loads 315 (obtained from the smart meters) and individual building characteristics 306 to generate a load shape prediction 316.

Load shape prediction 316 is then used by a control module 318, which calculates capacitor actuation values 319. Finally, capacitor actuation values 319 are used to actuate the capacitors 320 located in the distribution feeds.

### Power Factor Correction Process

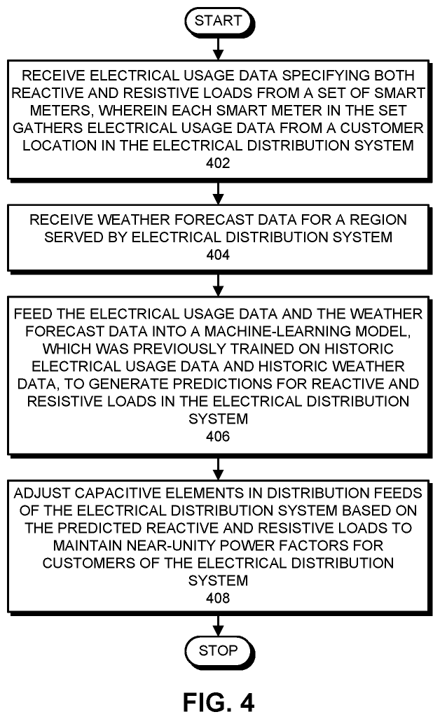

FIG. 4 presents a flow chart illustrating operations involved in performing power factor correction in an electrical distribution system in accordance with the disclosed embodiments. During operation, the system receives electrical usage data specifying both reactive and resistive loads from a set of smart meters, wherein each smart meter in the set gathers electrical usage data from a customer location in the electrical distribution system (step 402). The system also receives weather forecast data for a region served by electrical distribution system (step 404). The system then feeds the electrical usage data and the weather forecast data into a machine-learning model, which was previously trained on historic electrical usage data and historic weather data, to generate predictions for reactive and resistive loads in the electrical distribution system (step 406). Finally, the system adjusts capacitive elements in distribution feeds of the electrical distribution system based on the predicted reactive and resistive loads to maintain near-unity power factors for customers of the electrical distribution system (step 408).

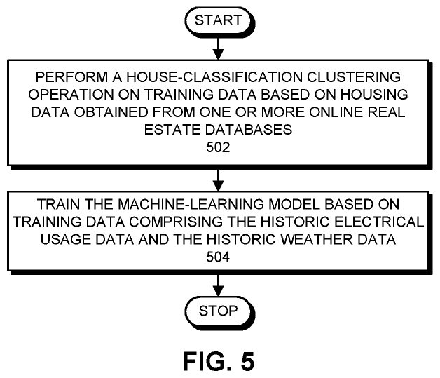

FIG. 5 presents a flow chart illustrating operations performed prior to performing the power factor correction in accordance with the disclosed embodiments. The system first performs a house-classification clustering operation on training data based on housing data obtained from one or more online real estate databases (step 502). Next, the system trains the machine-learning model based on training data comprising the historic electrical usage data and the historic weather data (step 504).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for performing power factor correction in an electrical distribution system, comprising:
receiving electrical usage data specifying both reactive and resistive loads from a set of smart meters, wherein each smart meter in the set gathers electrical usage data from a customer location in the electrical distribution system;
receiving weather forecast data for a region served by the electrical distribution system;
feeding the electrical usage data and the weather forecast data into a machine-learning model, which was previously trained on historic electrical usage data and historic weather data, to generate predictions for reactive and resistive loads in the electrical distribution system; and
adjusting capacitive elements in distribution feeds of the electrical distribution system based on the predicted reactive and resistive loads to maintain near-unity power factors for customers of the electrical distribution system.

2. The method of claim 1, wherein in addition to adjusting the capacitive elements in response to the predicted reactive and resistive loads, the method additionally comprises adjusting solar power inverters for customers with solar power systems.

3. The method of claim 1, wherein the capacitive elements and/or solar power inverters are adjusted using a nonlinear feedback-control mechanism.

4. The method of claim 1, wherein prior to receiving the electrical usage data, the method further comprises training the machine-learning model based on training data comprising the historic electrical usage data and the historic weather data.

5. The method of claim 4, wherein prior to training the machine-learning model, the method further comprises performing a house-classification clustering operation on the training data based on housing data obtained from one or more online real estate databases.

6. The method of claim 5, wherein the house-classification clustering operation is performed using a tri-point clustering technique.

7. The method of claim 1, wherein the predicted reactive and resistive loads comprise one or more predicted (Voltage Amperes Reactive) VAR-hour load shape curves projected several hours into the future.

8. The method of claim 1, wherein the machine-learning model comprises a regression model having a two-dimensional dependent variable representing reactive and resistive power components.

9. The method of claim 1, wherein the machine-learning model comprises a deep-learning neural network model in which neural network parameters are fitted using a gradient-descent technique.

10. The method of claim 1, wherein the weather forecast data is converted into a specific weather forecast for each customer location by triangulating data obtained from local weather stations and using a barycentric coordinate technique.

11. A non-transitory computer-readable storage medium storing instructions that when executed by a computer cause the computer to perform a method for performing power factor correction in an electrical distribution system, the method comprising:
receiving electrical usage data specifying both reactive and resistive loads from a set of smart meters, wherein each smart meter in the set gathers electrical usage data from a customer location in the electrical distribution system;
receiving weather forecast data for a region served by the electrical distribution system;
feeding the electrical usage data and the weather forecast data into a machine-learning model, which was previously trained on historic electrical usage data and historic weather data, to generate predictions for reactive and resistive loads in the electrical distribution system; and
adjusting capacitive elements in distribution feeds of the electrical distribution system based on the predicted reactive and resistive loads to maintain near-unity power factors for customers of the electrical distribution system.

12. The non-transitory computer-readable storage medium of claim 11, wherein in addition to adjusting the capacitive elements in response to the predicted reactive and resistive loads, the method additionally comprises adjusting solar power inverters for customers with solar power systems.

13. The non-transitory computer-readable storage medium of claim 11, wherein the capacitive elements and/or solar power inverters are adjusted using a nonlinear feedback-control mechanism.

14. The non-transitory computer-readable storage medium of claim 11, wherein prior to receiving the electrical usage data, the method further comprises training the machine-learning model based on training data comprising the historic electrical usage data and the historic weather data.

15. The non-transitory computer-readable storage medium of claim 14, wherein prior to training the machine-learning model, the method further comprises performing a house-classification clustering operation on the training data based on housing data obtained from one or more online real estate databases.

16. The non-transitory computer-readable storage medium of claim 11, wherein the weather forecast data is converted into a specific weather forecast for each customer location by triangulating data obtained from local weather stations and using a barycentric coordinate technique.

17. A system that forecasts electricity demand for a utility system, comprising:
at least one processor and at least one associated memory; and
a power-factor-correction mechanism that executes on the at least one processor, wherein during operation, the power-factor-correction mechanism,
receives electrical usage data specifying both reactive and resistive loads from a set of smart meters, wherein each smart meter in the set gathers electrical usage data from a customer location in the electrical distribution system,
receives weather forecast data for a region served by the electrical distribution system,
feeds the electrical usage data and the weather forecast data into a machine-learning model, which was previously trained on historic electrical usage data and historic weather data, to generate predictions for reactive and resistive loads in the electrical distribution system, and
adjusts capacitive elements in distribution feeds of the electrical distribution system based on the predicted reactive and resistive loads to maintain near-unity power factors for customers of the electrical distribution system.

18. The system of claim 17, wherein in addition to adjusting the capacitive elements in response to the predicted reactive and resistive loads, the power-factor-correction mechanism additionally adjusts solar power inverters for customers with solar power systems.

19. The system of claim 17, wherein the power-factor-correction mechanism adjusts the capacitive elements and/or solar power inverters using a nonlinear feedback-control mechanism.

20. The system of claim 17, wherein prior to receiving the electrical usage data, the power-factor-correction mechanism trains the machine-learning model based on training data comprising the historic electrical usage data and the historic weather data.
